(19) United States
(12) Patent Application Publication
(10) Pub. No.: US 2024/0227776 A9
(43) Pub. Date: Jul. 11, 2024

(54) CONTROL APPARATUS

(71) Applicant: DENSO CORPORATION, Kariya-city (JP)

(72) Inventors: Syuya KAMIZONO, Kariya-city (JP); Akira Sakamoto, Kariya-city (JP); Yuichi Handa, Kariya-city (JP); Masaki Amakawa, Kariya-city (JP); Keisuke Kawai, Kariya-city (JP)

(73) Assignee: DENSO CORPORATION, Kariya-city (JP)

(21) Appl. No.: 18/400,486

(22) Filed: Dec. 29, 2023

Related U.S. Application Data
(63) Continuation of application No. PCT/JP22/22887, filed on Jun. 7, 2022.

(30) Foreign Application Priority Data
Jul. 1, 2021 (JP) 2021-109814

(51) Int. Cl. B60W 20/15; F02N 11/08; H02P 23/04

(52) U.S. Cl. CPC B60W 20/15; F02N 11/0859; H02P 23/04; B60W 2710/083; F02N 2200/042; F02N 2250/00

(57) ABSTRACT

A control apparatus for a rotating electric machine is provided. The rotating electric machine includes a moving portion that applies torque to a drive shaft of an internal combustion engine. The control apparatus acquires a rotational frequency signal that is a signal that changes depending on a rotational frequency of the moving portion per unit time. The control apparatus calculates a damping torque that is applied from the moving portion to the drive shaft to suppress vibration during operation of the internal combustion engine. The control apparatus calculates the damping torque based on the rotational frequency signal acquired by the signal acquiring unit in response to the rotating electric machine performing cranking of the internal combustion engine.

### CROSS-REFERENCE TO RELATED APPLICATION

The present application is a continuation application of International Application No. PCT/JP2022/022887, filed on Jun. 7, 2022, which claims priority to Japanese Patent Application No. 2021-109814, filed on Jul. 1, 2021. The contents of these applications are incorporated herein by reference in their entirety.

### BACKGROUND

The present disclosure relates to a control apparatus for a rotating electric machine. For example, a power generator that is mounted in an electric vehicle or the like is provided with an internal combustion engine and a rotating electric machine. In such a power generator, the rotating electric machine generates power by a moving portion of the rotating electric machine rotating by torque that is generated by the internal combustion engine.

### SUMMARY

One aspect the present disclosure provides a control apparatus for a rotating electric machine. The rotating electric machine includes a moving portion that applies torque to a drive shaft of an internal combustion engine. The control apparatus acquires a rotational frequency signal that is a signal that changes depending on a rotational frequency of the moving portion per unit time. The control apparatus calculates a damping torque that is applied from the moving portion to the drive shaft to suppress vibration during operation of the internal combustion engine. The control apparatus calculates the damping torque based on the rotational frequency signal acquired by the signal acquiring unit in response to the rotating electric machine performing cranking of the internal combustion engine.

### BRIEF DESCRIPTION OF THE DRAWINGS

In the accompanying drawings:

FIG. 1 is a diagram schematically illustrating an overall configuration of a power generator including a control apparatus according to a present embodiment;

FIG. 2 is a block diagram for explaining control performed to maintain a rotational frequency of a rotating electric machine at a target rotational frequency;

FIG. 3 is a diagram illustrating pulsations in torque during operation of an internal combustion engine;

FIGS. 4A and 4B are diagrams illustrating changes over time in rotational frequency and torque during a period before and after startup of the internal combustion engine;

FIGS. 5A to 5D are diagrams for explaining a method for correcting a phase of a damping torque;

FIG. 6 is a diagram for explaining a method for correcting the phase of the damping torque; and

FIG. 7 is a flowchart illustrating a flow of processes performed by the control apparatus in FIG. 1.

### DESCRIPTION OF THE EMBODIMENTS

For example, a power generator that is mounted in an electric car or the like is provided with an internal combustion engine and a rotating electric machine. In such a power generator, the rotating electric machine generates power by a moving portion of the rotating electric machine rotating by torque that is generated by the internal combustion engine. At this time, when the rotating electric machine generates torque that periodically pulsates, variations in a rotational frequency of the internal combustion engine can be suppressed by the torque. This makes it possible to suppress vibration in the internal combustion engine and the like that occur in accompaniment with the variations in rotational frequency.

JP 3454249 B2 describes that an output torque of the rotating electric machine is adjusted based on resistance torque of the internal combustion engine, and vibration is thereby suppressed.

In an internal combustion engine that is in operation, combustion occurs at a timing at which a piston reaches a top dead center or a timing close thereto. Therefore, the periodic torque that is outputted from the rotating electric machine to suppress vibration is preferably at minimum at this timing.

As a method by which a control apparatus of the rotating electric machine ascertains the above-described timing, for example, reception of a signal that indicates a piston position or the like from a control apparatus (engine electronic control unit [ECU]) that controls the internal combustion engine can be considered. However, in such a configuration, for example, when a delay in communication between the control apparatuses over a communication network such as an onboard network occurs, the torque of the rotating electric machine may not be able to be changed at an appropriate timing. In addition, when communication is interrupted for some reason, control to suppress variations in a rotational frequency of the internal combustion engine by the rotating electric machine cannot be performed at all.

It is thus desired to provide a control apparatus for a rotating electric machine that is capable of stably performing control to suppress variations in a rotational frequency of an internal combustion engine.

An exemplary embodiment of the present disclosure provides a control apparatus for a rotating electric machine. The rotating electric machine has a moving portion that applies torque to a drive shaft of an internal combustion engine. The control apparatus includes: a signal acquiring unit that acquires a rotational frequency signal that is a signal that changes depending on a rotational frequency of the moving portion per unit time; and a torque calculating unit that calculates a damping torque that is applied from the moving portion to the drive shaft to suppress vibration during operation of the internal combustion engine. The torque calculating unit calculates the damping torque based on the rotational frequency signal acquired by the signal acquiring unit in response to the rotating electric machine performing cranking of the internal combustion engine. The torque calculating unit may calculate the damping torque to have a waveform that is synchronous with a waveform of the rotational frequency signal. The torque calculating unit may correct a phase of the damping torque based on a value of a normalized rotational frequency signal and a value of a normalized damping torque.

In the control apparatus having a configuration such as this, the signal acquiring unit acquires the rotational frequency signal when the rotating electric machine is cranking the internal combustion engine, that is, before the internal combustion engine is started. The rotational frequency signal such as this is a signal that changes depending on a position of a piston in the internal combustion engine and therefore includes information indicating the piston position in the internal combustion engine. Therefore, the torque calculating unit can calculate an appropriate damping torque that is synchronous with the piston position in the internal combustion engine by calculating the damping torque based on the rotational frequency signal.

Here, the rotational frequency signal is not a signal that is acquired through communication from a control apparatus that controls the internal combustion engine, but rather, a signal that can be directly acquired based on a signal from, for example, a sensor provided in the rotating electric machine. Consequently, the signal acquiring unit can stably acquire the rotational frequency signal at all times without being affected by interruptions in communication and the like. As a result, the above-described control apparatus can stably perform control to suppress variations in the rotational frequency of the internal combustion engine.

Thus, the exemplary embodiment makes it possible to provide a control apparatus for a rotating electric machine that is capable of stably performing control to suppress variations in a rotational frequency of an internal combustion engine.

A present embodiment will hereinafter be described with reference to the accompanying drawings. To facilitate understanding of the descriptions, identical constituent elements in the drawings are given the same reference numbers whenever possible. Redundant descriptions are omitted.

A control apparatus 10 according to the present embodiment is an apparatus that is mounted in a power generator PG and is configured as an apparatus for controlling operations of a rotating electric machine 30 provided in the power generator PG and the like. A configuration of the power generator PG will be described first, before a description of the control apparatus 10.

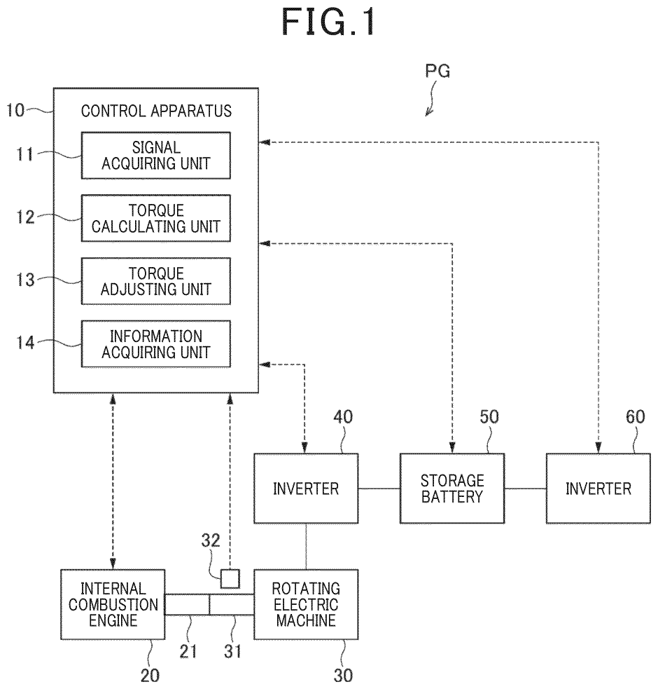

For example, the power generator PG is an apparatus that is mounted in a vehicle, such as an electric vehicle, and generates power required for traveling of the vehicle. For example, as a vehicle configured in this manner, a series-type hybrid vehicle can be given. Here, the power generator PG may be a power generator that is mounted in a vehicle as described above. However, the power generator PG may also be, for example, a stationary power generator that is set in a building. As shown in FIG. 1, the power generator PG includes an internal combustion engine 20, a rotating electric machine 30, an inverter 40, a storage battery 50, and an inverter 60.

The internal combustion engine 20 is an apparatus that generates torque (rotational force of a drive shaft 21) by burning fuel, and is a so-called reciprocal engine. The internal combustion engine 20 is provided with four cylinders (not shown). A piston that reciprocally moves up and down is disposed inside each cylinder. The up/down motion of the piston is converted to rotational motion of the drive shaft 21. The drive shaft 21 is also referred to as a “crank shaft.” Here, the number of cylinders provided in the internal combustion engine 20 may differ from four.

The rotating electric machine 30 is an apparatus that generates power by torque received from the internal combustion engine 20 and also referred to as a “motor generator.” The rotating electric machine 30 has a moving portion 31. When the moving portion 31 rotates by torque received from the internal combustion engine 20, the rotating electric machine 30 generates three-phase, alternating-current power. The power is supplied to the inverter 40. According to the present embodiment, the drive shaft 21 of the internal combustion engine 20 and the moving portion 31 of the rotating electric machine 30 are directly joined. That is, the moving portion 31 is fixed to the drive shaft 21. According to the present embodiment, the rotating electric machine 30 has an outer-rotor structure. However, the rotating electric machine 30 may have another structure.

“The moving portion 31 is fixed to the drive shaft 21” referred to herein means that a flywheel for stabilizing rotation speed, a damper for reducing pulsations in the rotation speed, a gear for changing the rotation speed, and the like are not interposed between the drive shaft 21 and the moving portion 31. Therefore, the rotational frequency of the drive shaft 21 per unit time and the rotational frequency of the moving portion 31 per unit time match each other at all times. Here, if these rotation frequencies match each other, a clutch for temporarily releasing coupling between the drive shaft 21 and the moving portion 31 may be provided between the rotation shaft 21 and the moving portion 31. Such mode is also included in the configuration in which “the moving portion 31 is fixed to the drive shaft 21.” In the description below, the rotational frequency per unit time may be simply referred to as “rotational frequency.”

The rotating electric machine 30 operates by receiving torque from the internal combustion engine 20, as described above. However, the rotating electric machine 30 can also rotate the moving portion 31 by being supplied electric power from outside. In this case, the moving portion 31 applies torque to the drive shaft 21 of the internal combustion engine 20. At startup of the internal combustion engine 20, an operation in which the rotating electric machine 30 rotates the drive shaft 21 of the internal combustion engine 20, that is, so-called “cranking” is performed.

The rotating electric machine 30 according to the present embodiment can also suppress variations in the rotation frequencies of the moving portion 31 and the drive shaft 21 by makes the moving portion 31 generate pulsating torque after the internal combustion engine 20 is started, that is, when the moving portion 31 rotates by receiving torque from the internal combustion engine 20. As a result, vibration during operation of the internal combustion engine 20 is suppressed. Torque that is generated as described above in the rotating electric machine 30 is also referred to, hereafter, as “damping torque.” The damping torque can be said to be torque that is applied from the moving portion 31 of the rotating electric machine 30 to the drive shaft 21 of the internal combustion engine 20 to suppress vibration during operation of the internal combustion engine 20. A manner in which the damping torque is calculated and outputted will be described hereafter.

A rotational frequency sensor 32 for detecting the rotational frequency of the moving part 31 is provided near the moving part 31. For example, the rotational frequency sensor 32 may be a resolver provided in the rotating electric machine 30. However, the rotational frequency sensor 32 may be another sensor. A signal indicating the rotational frequency of the moving part 31 is inputted from the rotational frequency sensor 32 to the control apparatus 10.

The inverter 40 is a power converter that converts the alternating-current power generated in the rotating electric machine 30 to direct-current power, and supplies the direct-current power to the storage battery 50. The inverter 40 can also convert direct-current power to an alternating-current power, and supply the alternating-current power to the rotating electric machine 30. In this manner, the inverter 40 is configured as a bi-directional power converter. The control apparatus 10 controls operation of the inverter 40. The control apparatus 10 can adjust the torque, the rotational frequency, and the like of the rotating electric machine 30 by controlling the operation of the inverter 40.

The storage battery 50 is for temporarily storing electric power that is to be outputted outside from the power generator PG. For example, the storage battery 50 may be a lithium-ion battery. The alternating-current power generated in the rotating electric machine 30 is supplied to and stored in the storage battery 50 after being converted into direct-current power by the inverter 40, as described above. In addition, a portion of the power stored in the storage battery 50 may be supplied to the rotating electric machine 30 through the inverter 40 and used as power for generating the damping torque in the rotating electric machine 30. Here, the damping torque may be generated by the inverter 40 adjusting regenerative power generated in the rotating electric machine 30, without using the power from the storage battery 50. The control apparatus 10 can acquire a state of the storage battery 50 by communicating with a control apparatus (not shown) mounted in the storage battery 50.

The inverter 60 is a power converter for converting power stored in the storage battery 50 to alternating-current power and outputting the alternating current power to the outside. For example, when the power generator PG is mounted in an electric vehicle, the power outputted from the inverter 60 is supplied to a rotating electric machine (not shown) for traveling that is mounted in the electric vehicle. In this case, the regenerative power generated during braking of the electric vehicle may be supplied to the storage battery 50 through the inverter 60. The control apparatus 10 controls operation of the inverter 60.

A configuration of the control apparatus 10 will be described also with reference to FIG. 1. As described earlier, the control apparatus 10 is configured as an apparatus for controlling the operation of the rotating electric machine 30 provided in the power generator PG and the like. The control apparatus 10 is configured as a computer system that has a central processing unit (CPU), a read-only memory (ROM), and the like. The control apparatus 10 includes a signal acquiring unit 11, a torque calculating unit 12, a torque adjusting unit 13, and an information acquiring unit 14 as blocks schematically expressing functions of the control apparatus 10.

The signal acquiring unit 11 is a section that performs a process to acquire a signal that changes depending on the rotational frequency of the moving portion 31 from the rotation speed sensor 32. The signal is also referred to, hereafter, as a “rotational frequency signal.” According to the present embodiment, the drive shaft 21 and the moving portion 31 are directly joined. Therefore, the rotational frequency signal can also be said to be a signal that changes depending on the rotational frequency of the drive shaft 21.

The torque calculating unit 12 is a section that performs a process to calculate the damping torque described earlier. The torque calculating unit 12 calculates a magnitude of the damping torque to be outputted to suppress vibration during operation of the internal combustion engine 20 by a method described hereafter.

The torque adjusting unit 13 is a section that performs a process to adjust the torque of the moving portion 31, that is, the torque that is actually outputted from the rotating electric machine 30. The torque adjusting unit 13 controls the operation of the inverter 40 such that the rotational frequency of the moving portion 31 coincides with a predetermined target value, and thereby adjusts the torque of the moving portion 31. In addition, the damping torque calculated by the torque calculating unit 12 is superimposed onto the torque of the moving portion 31 adjusted by the torque adjusting unit 13. That is, the torque adjusting unit 13 controls operation of the inverter 40 so that the torque actually outputted from the rotating electric machine 30 is torque obtained by the damping torque being superimposed onto the torque required for the rotational frequency of the moving portion 31 to coincide with the predetermined target value.

The information acquiring unit 14 is a section that performs a process to acquire information indicating an advance amount or a lag amount of the internal combustion engine by communicating with a control apparatus (not shown) that controls the internal combustion engine 20. “Information indicating an advance amount or a lag amount of the internal combustion engine 20” is information expressing a difference between a timing at which the piston in the cylinder of the internal combustion engine 20 reaches the top dead center and a timing at which ignition is performed in the cylinder by an amount of change in crank angle. This information is also referred to as “angle information.”

Here, the information acquiring unit 14 may acquire the angle information by a differing mode than that described above. For example, the information acquiring unit 14 may store, in advance, a map that indicates a correspondence between an operation state (such as the rotational frequency) of the internal combustion engine 20, and the advance amount or lag amount of the internal combustion engine 20, and acquire the angle information by referencing the map.

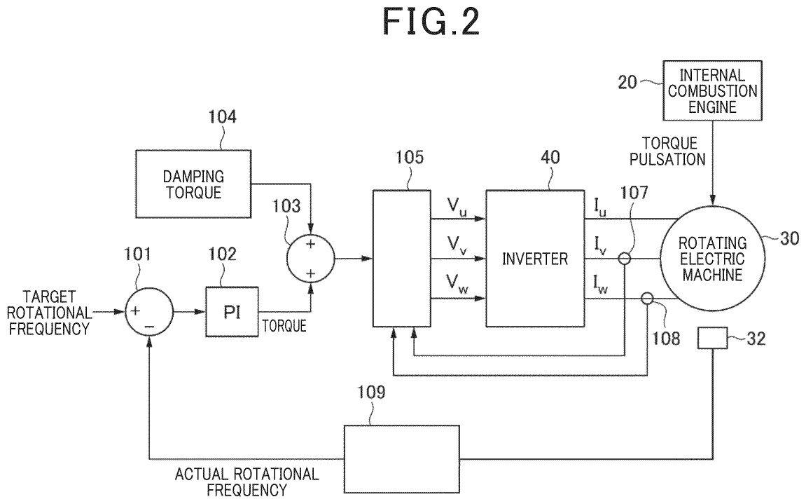

An overview of a process performed by the torque adjusting unit 13 and the like to adjust the torque of the rotating electric machine 30 will be described with reference to FIG. 2.

The rotational frequency signal from the rotational frequency sensor 32 is inputted to a subtracter 101 after being converted to an actual rotational frequency by a calculation block 109. The subtracter 101 performs a process to subtract the actual rotational frequency from a target rotational frequency that is a target value of the rotational frequency of the moving portion 31. A proportional integral (PI) calculator 102 converts a difference between the target rotational frequency and the actual rotational frequency to a torque command value of the rotating electric machine 30. The torque command value is inputted to a calculation block 105 that indicates a vector control system, through an adder 103 described hereafter. In the calculation block 105, the torque command value is converted to command values (Vu, Vv, Vw) of respective current values of a u-phase, a v-phase, and a w-phase, and the command values are inputted to the inverter 40. The inverter 40 supplies, to the rotating electric machine 30, currents (Iu, Iv, Iw) of phases composed of the u-phase, the v-phase, and the w-phase based on the command values, and the rotating electric machine 30 is thereby operated. The current Iv of the v-phase and the current Iw of the w-phase are respectively measured by current sensors 107 and 108, and fed back to the calculation block 105.

As a result of control such as the foregoing being performed, the torque of the rotating electric machine 30 is adjusted to substantially match the target rotational frequency. However, the moving portion 31 of the rotating electric machine 30 is joined to the drive shaft 21 of the internal combustion engine 20. Therefore, to be accurate, the rotational frequency of the moving portion 31 is not fixed, but rather varies due to effects of torque from the internal combustion engine 20.

Therefore, the control apparatus 10 according to the present embodiment adds the damping torque in a superimposing manner as the torque for suppressing variations in the rotational frequency as that described above. The damping torque calculated by the torque calculating unit 12 is inputted to the adder 103 from a calculation block 104 in FIG. 2, and added to the torque command value outputted from the PI calculator 102. As a result, the damping torque is superimposed onto the torque required for the rotational frequency of the moving portion 31 to coincide with the predetermined target value.

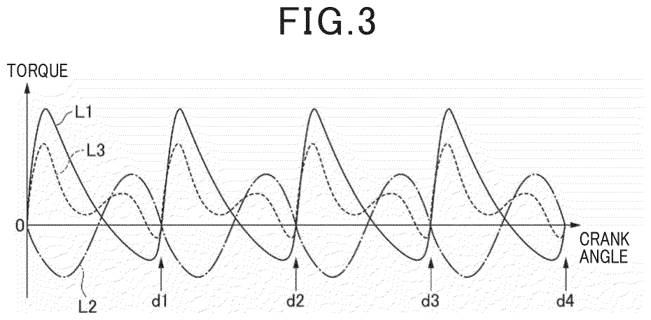

The torque of the internal combustion engine 20 will be described with reference to FIG. 3. In FIG. 3, an example of changes in various types of torque (vertical axis) in the internal combustion engine 20 when the crank angle (horizontal axis) of the internal combustion engine 20 changes is shown. The torque indicated by line L1 in FIG. 3 is torque generated as a result of combustion of fuel in the cylinder of the internal combustion engine 20. The torque indicated by line L1 is also referred to, hereafter, as “cylinder internal-pressure torque.”

The torque indicated by line L2 in FIG. 3 is torque generated as a result of inertial force when the piston moves up and down in the cylinder of the internal combustion engine 20. The torque indicated by line L2 is also referred to, hereafter, as “reciprocating mass inertial torque.” The torque indicated by line L3 is torque that is a sum of the cylinder internal-pressure torque indicated by line L1 and the reciprocating mass inertial torque indicated by line L2.

Each of d1, d2, d3, and d4 in FIG. 3 indicates a crank angle at a timing at which the piston reaches the top dead center in the cylinder. Combustion of fuel occurs immediately after each timing indicated by d1 and the like. Therefore, the torque in the internal combustion engine 20 indicated by line L3 is maximum at a timing that is substantially identical to each of the timings such as d1. Therefore, the torque calculating unit 12 preferably calculates the damping torque such that the pulsating damping torque is a minimum at the timing at which the torque in the internal combustion engine 20 indicated by line L3 is maximum. To calculate the damping torque as torque that pulsates in this manner, the control apparatus 10 is required to ascertain the timing, such as d1, at which the piston reaches the top dead center in each cylinder by a method of some sort.

For example, the timing, such as d1, at which the piston reaches the top dead center in each cylinder can be acquired by communication from a control apparatus that controls operation of the internal combustion engine 20, such as an engine ECU. However, when the timing is acquired by a method such as this, for example, when a delay in communication between the control apparatuses occur over a communication network, such as an onboard network, the damping torque may not be able to be appropriately outputted from the rotating electric machine 30. In addition, when communication is interrupted for some reason, control by the rotating electric machine 30 to suppress variations in the rotational frequency of the internal combustion engine 20 cannot be performed at all.

Therefore, in the control apparatus 10 according to the present embodiment, the damping torque is pulsated to change at appropriate timings (phases) through use of the rotational frequency signal from the rotational frequency sensor 32, without using information acquired through communication from the engine ECU.

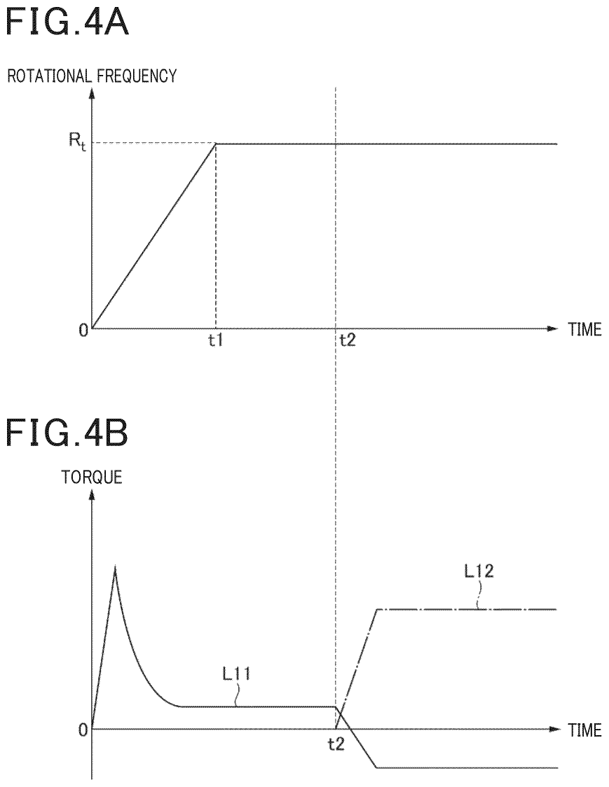

The timing at which the damping torque is calculated and outputted will be described with reference to FIGS. 4A and 4B. FIG. 4A is a graph of an example of changes overtime in the rotational frequency of the moving portion 31. In this example, the rotating electric machine 30 performs cranking during a period until time t2, and the internal combustion engine 20 is started at time t2. Of the period during which cranking is performed, during a period until time t1, the rotational frequency increases together with the elapse of time and reaches a predetermined rotational frequency Rt at time t1. During a period subsequent to time t1, the rotational frequency of the moving portion 31 is maintained at the target rotational frequency Rt. Here, in the example in FIGS. 4A and 4B, the target rotational frequency Rt is fixed even after time t2. However, the target rotational frequency Rt may be changed as appropriate after the internal combustion engine 20 is started.

Line L11 in FIG. 4B is a graph of an example of changes over time in the torque generated in the rotating electric machine 30. In addition, line L12 in FIG. 4B is a graph of an example of changes over time in the torque generated in the internal combustion engine 20. As indicated by line L12, during a period before time t2 when the internal combustion engine is started, the torque generated in the internal combustion engine 20 is 0. Torque in a positive direction is generated in the internal combustion engine 20 after time t2.

As indicated by line L11, when cranking is performed during the period until time t2, torque in the positive direction is generated in the rotating electric machine 30. This torque is kept at a positive value required to maintain the rotational frequency of the moving portion 31 at the target rotational frequency Rt after rapidly increasing and falling immediately after cranking is started.

After ignition is performed in the internal combustion engine 20 at time t2 and the internal combustion engine 20 is started, torque in a negative direction is generated in the rotating electric machine 30. This torque is torque that counters the torque of the internal combustion engine 20 required to maintain the rotation frequencies of the drive shaft 21 and the moving portion 31 at the target rotational frequency Rt. Here, in FIG. 4B, line L11 subsequent to time t2 is linearly drawn. However, changes in the actual torque have a pulsating waveform due to effects of the damping torque being superimposed.

According to the present embodiment, the torque calculating unit 12 calculates the damping torque during the period until time t2 when the internal combustion engine 20 is started, that is, during the period in which cranking is performed. During this period, the damping torque is only calculated and not actually outputted. That is, during this period, only the torque required to maintain the rotational frequency of the moving portion 31 at the target rotational frequency Rt is outputted from the rotating electric machine 30. However, the damping torque is not superimposed onto this torque.

The torque adjusting unit 13 starts superimposing the damping torque onto the torque outputted from the rotating electric machine 30 at time t2. The damping torque is prepared in advance during the period until time t2 as torque having a waveform in which the value of the damping torque is minimum at a timing at which the torque of the internal combustion engine 20 indicated by line L3 (or line L2) in FIG. 3 is maximum. Therefore, vibration during operation of the internal combustion engine 20 can be appropriately suppressed from a timing (time t2) immediately after the internal combustion engine 20 is started.

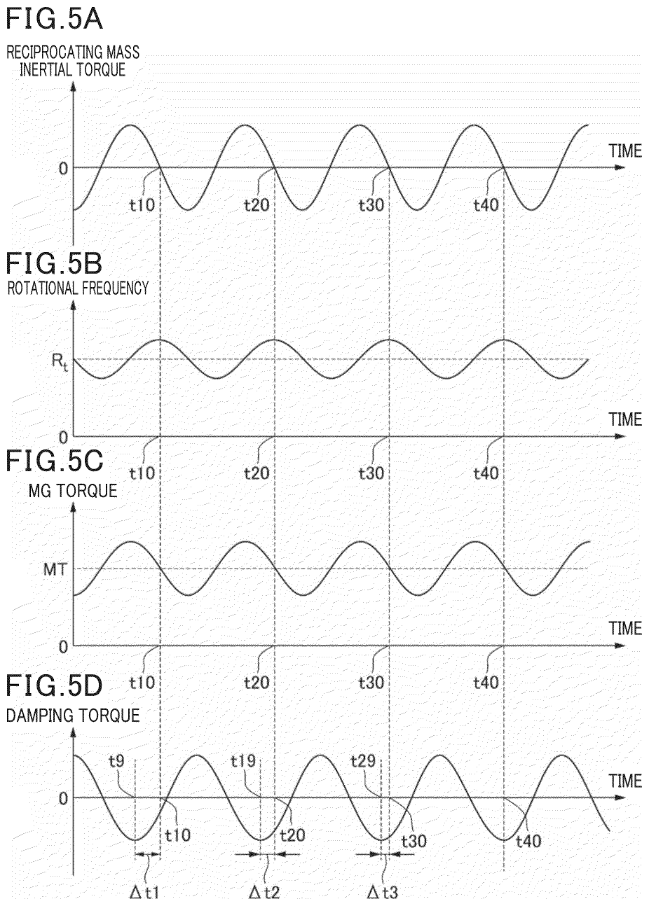

A method by which the torque calculating unit 12 calculates the damping torque during the period until time t2 will be described with reference to FIGS. 5A to 5D. In FIG. 5A, an example of changes in the reciprocating mass inertial torque in the internal combustion engine 20 is shown. FIG. 5B shows an example of changes in the rotational frequency of the moving portion 31. FIG. 5C shows an example of changes in the torque generated in the rotating electric machine 30. FIG. 5D shows an example of changes in the damping toque calculated by the torque calculating unit 12. All of the graphs shown in FIGS. 5A to 5D show examples of changes over time in parameters during a period before the internal combustion engine 20 is started. Therefore, the damping torque in FIG. 5D is only prepared and is not yet actually outputted.

During the period before the internal combustion engine 20 is started, in the internal combustion engine 20, the cylinder internal-pressure torque indicated by line L1 in FIG. 3 is not generated, and only the reciprocating mass inertial torque indicated by line L2 in FIG. 3 and indicated in FIG. 5A is generated. As shown in FIG. 3 and FIG. 5A, the reciprocating mass inertial torque changes in the shape of a sine wave together with the elapse of time.

In FIGS. 5A to 5D, the timings at which the piston reaches the top dead center in each cylinder are indicated as times t10, t20, t30, and t40. As shown in FIG. 5A, in terms of properties, the reciprocating mass inertial torque is 0 at each of the timings (such as time t10) at which the piston reaches the top dead center, and changes to switch from the positive direction to the negative direction at these timings.

During the period in which cranking is performed or, specifically, during the period subsequent to time t1 in FIG. 4A, the control apparatus 10 controls the operation of the rotating electric machine 30 through the inverter 40 so that the rotational frequency of the moving portion 31 coincides with the fixed target rotational frequency Rt. However, due to the effects of the reciprocating mass inertial torque that varies as in FIG. 5A, the rotational frequency of the moving portion 31 pulsates as shown in FIG. 5B. The rotational frequency of the moving portion 31 changes in a shape of a sine wave in a manner similar to the reciprocating mass inertial torque.

However, a phase of the rotational frequency is a phase that is delayed by ¼ of a cycle from a phase of the reciprocating mass inertial torque. Therefore, the rotational frequency of the moving portion 31 changes to be the maximum value at each of the timings (such as time t10) at which the piston reaches the top dead center. At this time, the torque that is generated in the rotating electric machine 30 changes as in FIG. 5C as a result of control by the control apparatus 10 being performed. The torque that is generated in the rotating electric machine 30 changes in the shape of a sine wave in a manner similar to the reciprocating mass inertial torque. In addition, the phase of the torque is identical to the phase of the reciprocating mass inertial torque.

Changes in the rotational frequency of the moving portion 31 shown in FIG. 5B, that is, the rotational frequency signals acquired by the signal acquiring unit 11 are affected by the reciprocating mass inertial torque shown in FIG. 5A, as described above. As a result, the rotational frequency signal is a signal that varies based on the position of the piston in the internal combustion engine 20, and includes information on the piston position of the internal combustion engine 20. Therefore, the torque calculating unit 12 calculates the appropriate damping torque that is synchronous with the piston position in the internal combustion engine 20, based on the rotational frequency signal that changes as shown in FIG. 5B.

A specific calculation method is as follows. The torque calculating unit 12 calculates the damping torque that changes together with time using expression (1), below.

Damping torque=A×sin(ω×t+φ+θ) (1)

In expression (1), A is an amplitude of the damping torque. For example, the torque calculating unit 12 may determine an amplitude A of the damping torque by referencing a map that indicates a correspondence between the rotational frequency of the moving portion 31 and the amplitude.

In expression (1), ω is an angular velocity of changes in damping torque. For example, the torque calculating unit 12 may calculate the angular velocity ω using expression (2), below.

ω=RR×n/2 (2)

In expression (2), RR is a numeric value indicating the rotational frequency of the moving portion 31 in units of radian per second. In expression (2), n is a number of cylinders provided in the internal combustion engine 20. According to the present embodiment, n=4.

In expression (1), t is elapsed time (seconds) from a certain time (such as a time at which cranking is started). The torque calculating unit 12 continues calculation such that the most recent value of the damping torque is always used while updating t based on a current time.

In expression (1), φ is a parameter for correcting the phase of the damping torque. The torque calculating unit 12 brings the timing at which the value of the damping torque is minimum closer to the timing (such as time t10) at which the piston reaches the top dead center in each cylinder by adjusting the value of φ. The torque calculating unit 12 corrects the damping torque by a method such as this and brings the damping torque closer to an ideal damping torque.

In an example shown in FIG. 5D, the value of the damping torque is minimum at time t9 before time t10 at which the piston reaches the top dead center. Therefore, the torque calculating unit 12 decreases p in expression (1) by a predetermined amount, for example, to shorten a period Δt1 from time t9 to t10. For example, this process may be performed immediately after time t10.

As a result, a period Δt2 from time t19 at which the value of the damping torque subsequently becomes minimum to time t20 at which the piston reaches the top dead center is shorter than Δt1. The torque calculating unit 12 decreases φ in expression (1) by the predetermined amount to further shorten the period Δt2. As a result, a period Δt3 from time t29 at which the value of the damping toque subsequently becomes minimum to time t30 at which the piston reaches the top dead center is further shorter than Δt2. As a result of repeating the process to adjust the value of φ in this manner, the torque calculating unit 12 brings the timing at which the value of the damping torque becomes minimum closer to the timing at which the piston reaches the top dead center. A state in which the timing at which the value of the damping torque becomes minimum and the timing at which the piston reaches the top dead center substantially coincide with each other can be achieved before cranking ends.

In expression (1), θ is the advance amount or the lag amount of the internal combustion engine 20. When ignition is performed in a cylinder of the internal combustion engine 20 after the timing at which the piston reaches the top dead center in the cylinder, that is, when ignition timing is lagged, the value of θ is a negative value based on the extent of lag. Conversely, when the ignition timing is advanced, the value of θ is a positive value based on the extent of advancement. The value of θ is set based on angle information acquired by the information acquiring unit 14. However, according to the present embodiment, the value of θ is 0 during a period before the damping toque is actually outputted.

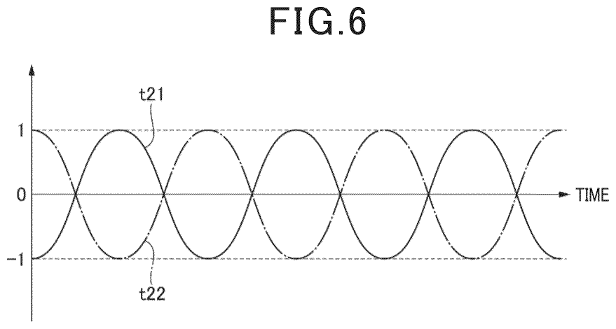

An example of a specific method for setting p in expression (1) will be described. Line L21 shown in FIG. 6 is a graph showing normalization of changes in the rotational frequency of the moving portion 31, that is, changes in the rotational frequency shown in FIG. 5B. “Normalization” herein refers to adjustments made in the graph of changes in the rotational frequency of the moving portion 31 to set an amplitude of the rotational frequency to ±1 and a center value to 0, while maintaining the phase of the rotational frequency. For example, normalization of the rotational frequency of the moving portion 31 can be performed by a value obtained by the target rotational frequency Rt being subtracted from a measurement value of the rotational frequency of the moving portion 31 being divided by the amplitude of the rotational frequency at this time. A value expressed by line L21 can be said to be a value of a normalized rotational frequency signal.

Line L22 shown in FIG. 6 is a graph of changes in the damping torque normalized in manner similar to line L21. A value indicated by line L22 can be said to be a value of the normalized damping torque.

If a timing at which the value of the damping torque becomes minimum and the timing at which the piston reaches the top dead center substantially coincides with each other, a sum of the value of the normalized rotational frequency signal (line L21) and the value of the normalized damping torque (line L22) is 0. Meanwhile, when the foregoing timings are shifted, the sum of the value of the normalized rotational frequency signal (line L21) and the value of the normalized damping torque (line L22) is a value other than 0.

Therefore, if φ is set based on the sum of the value of the normalized rotational frequency signal (line L21) and the value of the normalized damping torque (line L22) at a certain timing, correction of damping torque by φ can be performed with relative ease. In this case, correspondence between the sum and Φ described above may be stored in advance as a map. As the “certain timing” described above, for example, a timing at which the value of the rotational frequency signal becomes a maximum value or the like can be used.

Here, in calculating φ, instead of the value of the normalized rotational frequency signal (line L21), normalized changes in torque (FIG. 5C) generated in the rotating electric machine 30 may be used. In this case, φ can be calculated by a method similar to that described above, if the changes in torque generated in the rotating electric machine 30 are subjected to a calculation process to delay the phase thereof by ¼ of a cycle and normalized.

In addition, the changes in torque generated in the rotating electric machine 30 that is normalized upon being subjected to a calculation process to advance the phase thereof by ¼ of a cycle may be used. In this case, the p may be set based on a difference between the value of the normalized torque of the rotating electric machine 30 and the value of the normalized damping torque.

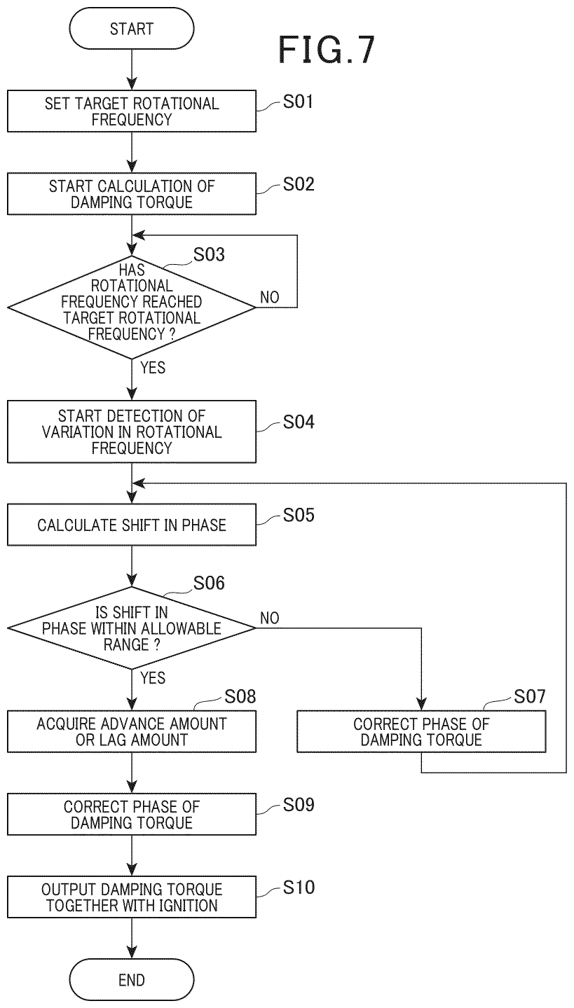

A specific flow of processes performed by the control apparatus 10 to actualize the calculation of the damping toque and the like described above will be described with reference to FIG. 7. The series of processes shown in FIG. 7 are performed immediately after the rotating electric machine 30 starts cranking the internal combustion engine 20.

At an initial step S01 in the process, a process to set the target rotational frequency is performed. The target rotational frequency is the target rotational frequency Rt in the example in FIGS. 4A and 4B. The target rotational frequency may be set to a value that is the same at all times or may be set to differing values depending on the situation.

At step S02 following step S0L, the torque calculating unit 12 starts calculation of the damping torque. Here, the damping torque is calculated using expression (1) described earlier. Subsequently, the value of the damping torque is repeatedly calculated and updated using t that corresponds to the current time at that point in time. Here, during a period until step S07 described hereafter, an initial value that is a temporary value is used as φ in expression (1). In addition, during a period until step S09 described hereafter, θ in expression (1) is 0. Here, the damping torque at this point in time is merely calculated and not yet actually outputted. The damping torque is outputted from step S10 described hereafter.

At step S03 following step S02, whether the rotational frequency of the moving portion 31 has reached the target rotational frequency set at step S01 is determined. For example, the determination may be performed based on the rotational frequency signal acquired by the signal acquiring unit 11.

When the rotational frequency of the moving portion 31 has not yet reached the target rotational frequency, the process at step S03 is repeated again. When the rotational frequency of the moving portion 31 is the target rotational frequency, the process proceeds to step S04. In parallel thereto, the control apparatus 10 performs the process described with reference to FIG. 2 to keep the subsequent rotational frequency of the moving portion 31 at the target rotational frequency.

At step S04, a process to detect variations in the rotational frequency of the moving portion 31 is started. Specifically, a process to acquire the changes in the rotational frequency of the moving portion 31 as the graph of changes over time that vary as shown in FIG. 5B is started.

At step S05 following step S04, a process to calculate phase shift is performed. The “phase shift” refers to a difference between the timing at which the piston reaches the top dead center and the timing at which the value of the damping torque is minimum, such as that indicated by Δt1 and Δt2 in FIG. 5D.

At step S06 following step S05, whether the above-described phase shift is within an allowable range is determined. Specifically, when an absolute value of the shift shift calculated at step S05 is equal to or less than a predetermined threshold, the phase shift is determined to be within the allowable range. Otherwise, the phase shift is determined to exceed the allowable range.

When the phase shift is determined to exceed the allowable range at step S06, the process proceeds to step S07. At step S07, a process to correct the phase of the damping torque is performed. This process is performed by the torque calculating unit 12. Here, the value of φ in expression (1) is updated by the method described earlier with reference to FIG. 6. Subsequently, the process at step S05 and subsequent thereto are performed again.

When the phase shift is determined to be within the allowable range at step S06, the process proceeds to step S08. At step S08, the information acquiring unit 14 performs a process to acquire the angle information. At step S09 subsequent to step S08, the torque calculating unit 12 sets the value of θ based on the angle information. Subsequently, the phase of the damping torque calculated by the expression (1) is corrected using θ.

Upon completion of the process at step S09, the rotational frequency of the moving portion 31 is substantially maintained at the target rotational frequency, and the timing at which the value of the damping toque is minimum and the timing at which the piston reaches the top dead center are in a state of coinciding with each other. That is, the damping torque is in a state of being appropriately prepared.

At step S10 following step S09, ignition in the internal combustion engine 20 is started and operation of the internal combustion engine 20 is started as a result. This process is performed while the control apparatus (engine ECU) that controls the process of the internal combustion engine 20 keeps track of timing through cooperation with the control apparatus 10.

When the ignition in the internal combustion engine 20 is started, the control apparatus 10 almost simultaneously starts to superimpose the damping torque onto the torque outputted from the rotating electric machine 30 (that is, the torque of the moving portion 31). As a result, the appropriate damping torque is outputted from the rotating electric machine 30 from when the operation of the internal combustion engine 20 is initially started. Therefore, variations in the rotational frequency of the internal combustion engine 20 can be suppressed. The timing at which the damping torque starts to be outputted is preferably the same as the timing at which ignition in the internal combustion engine 20 is performed, but may be slightly after the ignition in the internal combustion engine 20 is performed.

As described above, in the control apparatus 10 according to the present embodiment, the torque calculating unit 12 calculates the damping torque based on the rotational frequency signal acquired by the signal acquiring unit 11, when the rotating electric machine 30 is cranking the internal combustion engine 20 (before time t2 in FIGS. 4A and 4B). In addition, the torque adjusting unit 13 of the control apparatus 10 starts to superimpose the damping torque onto the torque of the moving portion 31 at the timing at which the internal combustion engine 20 is started (the timing at time t2 in FIGS. 4A and 4B). As a result, control to suppress the variations in rotational frequency of the moving portion 31 can be stably performed without depending on communication between control apparatuses. In addition, the damping torque is corrected in real time based on the rotational frequency signal. Therefore, even when the rotation frequencies of the drive shaft 21 and the moving portion 31 change, the variations in rotational frequency of the internal combustion engine 20 can be reliably suppressed.

The torque calculating unit 12 calculates the damping torque in FIG. 5D to have the waveform that is synchronous with the waveform of the rotational frequency signal such as that shown in FIG. 5B. Specifically, the torque calculating unit 12 calculates the damping torque such that phase shift (such as Δt1) between the waveform of the rotational frequency signal and the waveform of the damping torque is closer to 0. As a result, the waveform of the calculated damping torque is a waveform appropriate for suppressing the variations in rotational frequency of the internal combustion engine 20. The “the waveform is synchronous” above refers to a cycle at which the waveform (FIG. 5B) of the rotational frequency signal becomes the maximum value or the minimum value and a cycle at which the waveform (FIG. 5D) of the damping torque becomes the maximum or minimum value coinciding with each other.

As described with reference to FIG. 6, the torque calculating unit 12 sets p based on the value of the normalized rotational frequency signal (line L21 in FIG. 6) and the value of the normalized damping torque (line L22 in FIG. 6), and corrects the phase of the damping torque using this φ. As a result of a method such as this, the phase shift between the waveform of the rotational frequency signal and the waveform of the damping torque can be brought closer to 0 by a relatively easy calculation.

At step S09 in FIG. 7, the torque calculating unit 12 corrects the phase of the damping torque based on the angle information. As a result, the timing at which the internal pressure of the cylinder in the internal combustion engine 20 becomes maximum and the timing at which the value of the damping torque becomes minimum can be made to more accurately coincide.

According to the present embodiment, the drive shaft 21 of the internal combustion engine 20 and the moving portion 31 of the rotating electric machine 30 are directly joined by a bolt or the like. That is, the moving portion 31 is fixed to the drive shaft 21. In a configuration such as this, because the rotational frequency of the drive shaft 21 coincides with the rotational frequency of the moving portion 31, the appropriate damping torque can be calculated based on the rotational frequency signal. However, in a configuration in which a gear, a damper, or the like is interposed between the drive shaft 21 and the moving portion 31 as well, the damping torque can be calculated by a method similar to that according to the present embodiment.

A control target of the control apparatus 10 is merely required to be an apparatus that is configured such that the internal combustion engine 20 and the rotating electric machine 30 are connected to each other, and may be an apparatus that differs from the power generator PG such as that according to the present embodiment. For example, the internal combustion engine 20 may be used to generate driving force in a vehicle, and the rotating electric machine may be an apparatus that is provided as a dedicated apparatus for suppressing variations in the rotational frequency of the internal combustion engine 20. In such an apparatus as well, the control apparatus 10 can suppress vibration during operation of the internal combustion engine 20 by performing control similar that according to the present embodiment.

The present embodiment is described above with reference to specific examples. However, the present disclosure is not limited to these specific examples. Design modifications to the above-described specific examples made as appropriate by a person skilled in the art are included in the scope of the present disclosure as long as features of the present disclosure are included. Elements included in the above-described specific examples, as well as arrangements, conditions, shapes, and the like thereof are not limited to those given as examples and can be modified as appropriate. Combinations of elements included in the above-described specific examples can be changed as appropriate as long as technical inconsistencies do not occur.

The control apparatus and a control method described in the present disclosure may be actualized by a single or a plurality of dedicated computers that are each provided such as to be configured by a processor and a memory, the processor being programmed to provide a single or a plurality of functions that are realized by a computer program. The control apparatus and a control method thereof described in the present disclosure may be actualized by a dedicated computer that is provided by a processor being configured by a single or a plurality of dedicated hardware logic circuits. The control apparatus and a control method thereof described in the present disclosure may be actualized by a single or a plurality of dedicated computers that are each configured by a combination of a processor that is programmed to provide a single or a plurality of functions, a memory, and a processor that is configured by a single or a plurality of hardware logic circuits. The computer program may be stored in a non-transitory computer-readable (tangible) storage medium that can be read by a computer as instructions performed by the computer. The dedicated hardware logic circuit and the hardware logic circuit may be actualized by a digital circuit that includes a plurality of logic circuits or an analog circuit.

For example, one modification of the present embodiment may provide a control apparatus for a rotating electric machine that includes a moving portion that applies torque to a drive shaft of an internal combustion engine. The control apparatus may include: a processor; a non-transitory computer-readable storage medium; and a set of computer-executable instructions stored on the computer-readable storage medium that, when read and executed by the processor, cause the processor to implement: acquiring a rotational frequency signal that is a signal that changes depending on a rotational frequency of the moving portion per unit time; calculating a damping torque that is applied from the moving portion to the drive shaft to suppress vibration during operation of the internal combustion engine; and calculating the damping torque based on an acquired rotational frequency signal in response to the rotating electric machine performing cranking of the internal combustion engine. In the control apparatus, the set of computer-executable instructions may further cause the processor to implement: calculating the damping torque to have a waveform that is synchronous with a waveform of the rotational frequency signal; and correcting a phase of the damping torque based on a value of a normalized rotational frequency signal and a value of a normalized damping torque.

Another modification of the present embodiment may provide a control method for a rotating electric machine that includes a moving portion that applies torque to a drive shaft of an internal combustion engine. The control method may include: acquiring a rotational frequency signal that is a signal that changes depending on a rotational frequency of the moving portion per unit time; calculating a damping torque that is applied from the moving portion to the drive shaft to suppress vibration during operation of the internal combustion engine; and calculating the damping torque based on an acquired rotational frequency signal in response to the rotating electric machine performing cranking of the internal combustion engine. The control method may further include: calculating the damping torque to have a waveform that is synchronous with a waveform of the rotational frequency signal; and correcting a phase of the damping torque based on a value of a normalized rotational frequency signal and a value of a normalized damping torque.

What is claimed is:

1. A control apparatus for a rotating electric machine that includes a moving portion that applies torque to a drive shaft of an internal combustion engine, the control apparatus comprising:
a signal acquiring unit that acquires a rotational frequency signal that is a signal that changes depending on a rotational frequency of the moving portion per unit time; and
a torque calculating unit that calculates a damping torque that is applied from the moving portion to the drive shaft to suppress vibration during operation of the internal combustion engine, wherein
the torque calculating unit calculates the damping torque based on the rotational frequency signal acquired by the signal acquiring unit in response to the rotating electric machine performing cranking of the internal combustion engine,
the torque calculating unit calculates the damping torque to have a waveform that is synchronous with a waveform of the rotational frequency signal, and
the torque calculating unit corrects a phase of the damping torque based on a value of a normalized rotational frequency signal and a value of a normalized damping torque.

2. The control apparatus according to claim 1, further comprising:
a torque adjusting unit that adjusts torque of the moving portion, wherein
the torque adjusting unit starts to superimpose the damping torque onto the torque of the moving portion at a timing at which the internal combustion engine is started.

3. The control apparatus according to claim 1, further comprising:
an information acquiring unit that acquires angle information that is information on an advance amount or a lag amount of the internal combustion engine, wherein
the torque calculating unit corrects the phase of the damping torque based on the angle information.

4. The control apparatus according to claim 1, wherein:
the moving portion is fixed to the drive shaft.

5. The control apparatus according to claim 2, wherein:
the moving portion is fixed to the drive shaft.

6. The control apparatus according to claim 3, wherein:
the moving portion is fixed to the drive shaft.

7. A control apparatus for a rotating electric machine that includes a moving portion that applies torque to a drive shaft of an internal combustion engine, the control apparatus comprising:
a processor;
a non-transitory computer-readable storage medium; and
a set of computer-executable instructions stored on the computer-readable storage medium that, when read and executed by the processor, cause the processor to implement:
acquiring a rotational frequency signal that is a signal that changes depending on a rotational frequency of the moving portion per unit time;
calculating a damping torque that is applied from the moving portion to the drive shaft to suppress vibration during operation of the internal combustion engine;
calculating the damping torque based on an acquired rotational frequency signal in response to the rotating electric machine performing cranking of the internal combustion engine;
calculating the damping torque to have a waveform that is synchronous with a waveform of the rotational frequency signal; and
correcting a phase of the damping torque based on a value of a normalized rotational frequency signal and a value of a normalized damping torque.

8. A control method for a rotating electric machine that includes a moving portion that applies torque to a drive shaft of an internal combustion engine, the control method comprising:
acquiring a rotational frequency signal that is a signal that changes depending on a rotational frequency of the moving portion per unit time;
calculating a damping torque that is applied from the moving portion to the drive shaft to suppress vibration during operation of the internal combustion engine;
calculating the damping torque based on an acquired rotational frequency signal in response to the rotating electric machine performing cranking of the internal combustion engine;
calculating the damping torque to have a waveform that is synchronous with a waveform of the rotational frequency signal; and
correcting a phase of the damping torque based on a value of a normalized rotational frequency signal and a value of a normalized damping torque.
